(19) United States
(12) Patent Application Publication
(10) Pub. No.: US 2007/0186381 A1
(43) Pub. Date: Aug. 16, 2007

(54) DEVICE FOR CLOSING A FRAME HAVING A PANEL ARTICULATED ON THE FRAME

(75) Inventor: Jean-Jacques Monneret, Lyon (FR)

Correspondence Address: LEYDIG VOIT & MAYER, LTD, 700 THIRTEENTH ST. NW, SUITE 300, WASHINGTON, DC, 20005-3960, US

(73) Assignee: NORINCO, Saint Crepin Ibouvilliers (FR)

(21) Appl. No.: 11/617,869

(22) Filed: Dec. 29, 2006

(30) Foreign Application Priority Data
Feb. 14, 2006 (FR) 06 50 520

(51) Int. Cl. E05D 7/10

(52) U.S. Cl. 16/267

(57) ABSTRACT

A device for closing a frame, which has a panel mounted removably on and articulated on the frame includes a hook that has, at an end part, a heel that can stop against a surface of the articulation edge of the frame to immobilize the panel in a secure open upright position, generally perpendicular to the frame. The invention can be applied to roads.

### FIELD OF THE INVENTION

The present invention relates to a device making it possible to close a frame, which has a panel, such as a plug or cover, mounted in a removable manner articulated on a frame.

It applies in particular to road fittings allowing access to drains buried in the ground.

### BACKGROUND

Known through French patent No. 2 815 979 is a device for closing the opening of a frame by a panel mounted in a removable manner articulated on the frame by a hook connected to the panel and provided with an articulation eye in which a hinge pin is engaged, which pin has a flat part with an inclination relative to the frame greater than a right angle so that the panel can be mounted on the frame or extracted from it only in an open position overturned at approximately 110°.

According to this known device, the hook has, at its free end, a heel which, in the open overturned position of the panel, falls to rest along a steep side of an inclined cam of the articulation edge of the frame so as to immobilize the panel in its open position relative to the frame and to the hinge pin by four stop points. This arrangement has the disadvantage that the operator has difficulty freeing the panel from its four stop points by lifting and allowing the tilting of the panel to its position for closing the frame.

### SUMMARY OF THE INVENTION

The present invention aims to eliminate the disadvantage above of the known device by proposing a device that allows the panel to tilt freely from its overturned opening position and that makes it possible to immobilize the panel automatically in an upright position roughly perpendicular to the frame when the panel is tilted accidentally from its overturned opening position to its position for closing the frame.

To this effect, according to the invention, the device making it possible to close a frame, which has a panel, such as a plug or cover, mounted in a removable manner on the frame by a hook connected to the panel and provided with at least one internal lateral opening whose edges are configured in the form of inclines cooperating with a hinge pin connected to an articulation edge of the frame and engaged in the lateral opening of the hook in order to control the pivoting of the panel from its opening position to its position for closing of the frame in which it is inscribed in the peripheral rim of the frame and is applied on a rabbet of the frame or vice versa, the hinge pin having at least one flat part which, with respect to the frame, has an inclination greater than a right angle, and the lateral opening of the hook emerging at the end of the hook through a guide of reduced cross section, which allows the engagement of the hinge pin in the lateral opening of the hook by mutual drawing of the panel in open position near to the frame only according to an angle of inclination of the panel relative to the frame that is determined by the angle of inclination of the flat part of the hinge pin so that the panel can be mounted on or removed from the frame only in an overturned position, is characterized by the fact that the hook and the hinge pin allow free tilting of the panel from its overturned open position to its closing position, and the hook, at an end part, has a heel that can stop against a steep side of the articulation edge of the frame in order to immobilize the panel in a secure open upright position roughly perpendicular to the frame when the panel is tilted accidentally from its overturned open position, the hinge pin and the inclines of the lateral opening of the hook cooperating in order to prevent extraction of the panel occupying its secure open upright position from the frame while allowing the tilting of the panel to its position for closing the frame from its secure open upright position.

Preferably, the hook has a second lateral opening separated from the first lateral opening by a sheet of material of the hook and whose edges configured in the form of inclines cooperate with a second hinge pin connected to the articulation edge of the frame engaged in the second lateral opening of the hook in order also to control the pivoting of the panel from its opening position to its position for closing of the frame or vice versa, the second hinge pin having at least one flat part with the same inclination as the flat part of the first hinge pin, and the second lateral opening of the hook emerging at the end of the hook through a second guide of reduced cross section allowing engagement of the second hinge pin in the second lateral opening of the hook by mutual drawing of the panel in overturned open position near to the frame only according to the angle of inclination of the panel relative to the frame determined by the angle of inclination of the flat part of the second hinge pin, and the inclines of the second lateral opening of the hook cooperating also in order to prevent extraction, relative to the frame, of the panel occupying its secure open upright position.

The two hinge pins are coaxial, and each hinge pin has a second flat part opposite and parallel to the first flat part.

The articulation edge of the frame has a lower planar surface inclined downward towards the exterior of the frame and ending towards the interior of the frame with the stop side for the heel of the hook.

In the secure opening upright position of the panel, the hook rests by its other adjacent end part without the heel on the inclined surface of the frame and is stopped by the corresponding incline of each lateral opening against the corresponding hinge pin.

In its overturned opening position, the panel rests by its other adjacent end part of the hook without the heel on the inclined planar surface of the frame and by its external surface on an upper inclined surface of the rim of the frame, and is stopped by the corresponding guide with reduced cross section against the associated hinge pin.

The heel of the hook has a shape in cam form arranged on the exterior lower corner of this heel and cooperating with the inclined surface of the frame in order to control the pivoting of the panel during its tilting.

According to one embodiment, the articulation edge of the frame consists of a lug projecting outside the frame, intended for receiving the hook of the panel and of which each hinge pin is arranged transversely in the lug.

The panel can be circular, and the hook extends radially from this panel, whereas the lug is connected radially to the circular frame.

The panel is inclined to its overturned open position according to an angle between approximately 110° and approximately 120°.

### BRIEF DESCRIPTION OF THE DRAWING FIGURES

The invention will be better understood, and other aims, characteristics, details and advantages of it will appear more clearly in the course of the following explanatory description in reference to the appended drawings given only as examples illustrating an embodiment of the invention and in which:

FIG. 1 is a partial view in perspective of a road fitting with a panel mounted in a removable manner articulated to a frame;

FIG. 2 is an enlarged view in perspective of the circled part in II [sic] of FIG. 1 without the panel;

FIG. 3 is a front view according to arrow III of FIG. 2;

FIG. 4 is a view in perspective of the hook for articulation of the panel to the frame of the road fitting;

FIG. 5 is a partial view in section of the device of the invention according to line V-V of FIG. 1, with the panel occupying its position for closing the frame;

FIG. 6 is a view similar to that of FIG. 5 and representing the tilting of the panel from its closing position to its position for opening the frame;

FIG. 7 represents the panel in its overturned opening position with respect to the frame;

FIG. 8 shows the possibility for mounting the panel in the frame or removing the panel from the frame in the overturned opening position of this panel;

FIG. 9 shows the upright position for immobilization of the panel with respect to the frame following accidental tilting of the panel from its overturned opening position; and

FIG. 10 shows the releasing of the panel from its upright position of FIG. 9 without possibility of extraction of the panel from this frame.

### DETAILED DESCRIPTION

The device of the invention will be described as applied to a road manhole composed of a circular frame and a circular capping element or plug or cover panel making it possible to close the frame, but it is quite obvious that it can apply to a road manhole whose frame can be rectangular and closed by at least one rectangular or triangular capping element.

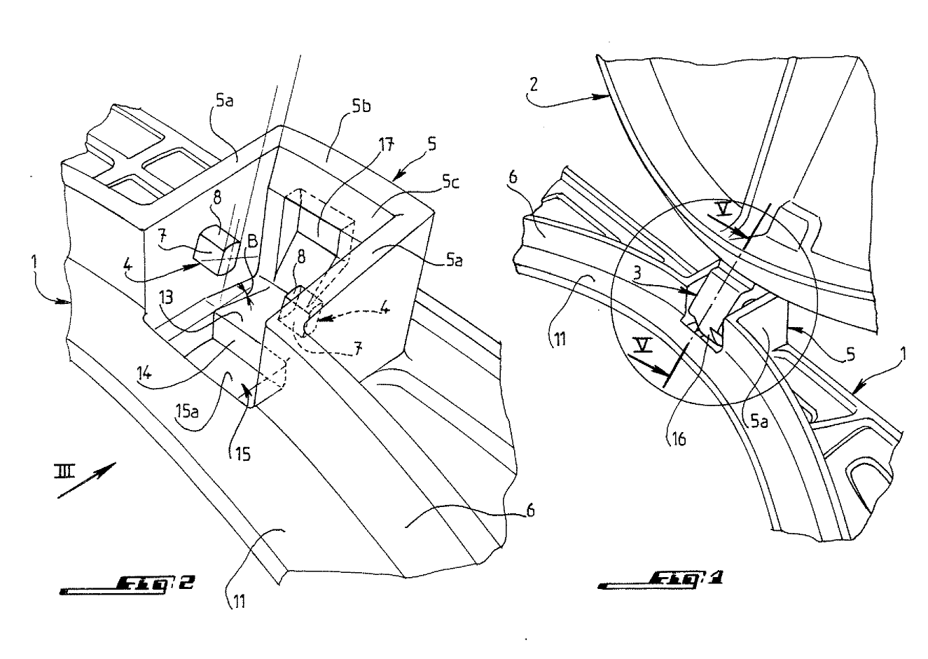

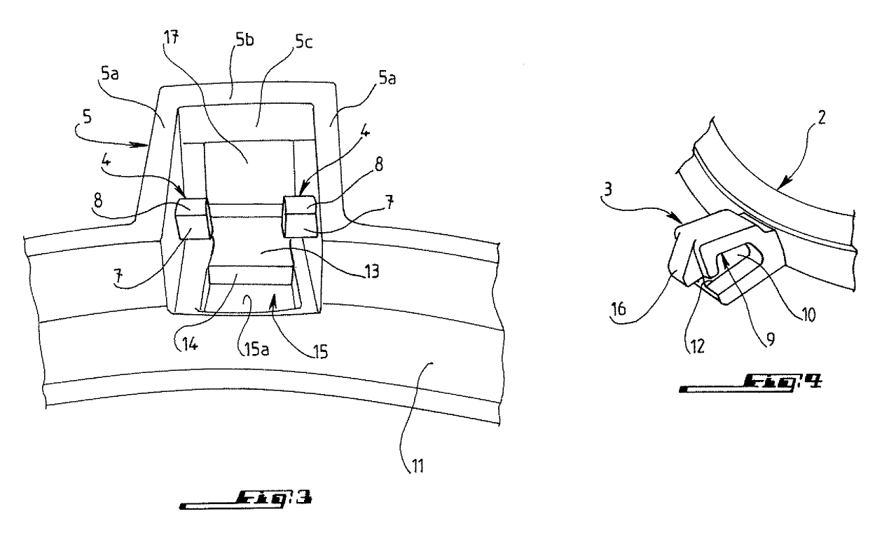

The manhole represented in FIGS. 1-10 therefore has circular frame 1 and plug 2 provided with radial hook 3 that is mounted articulated on two coaxial hinge pins 4 arranged transversely in lug 5 projecting exteriorly from peripheral rim 6 of frame 1 bordering the opening of this frame and in which plug 2 is inscribed in its position for closing the frame.

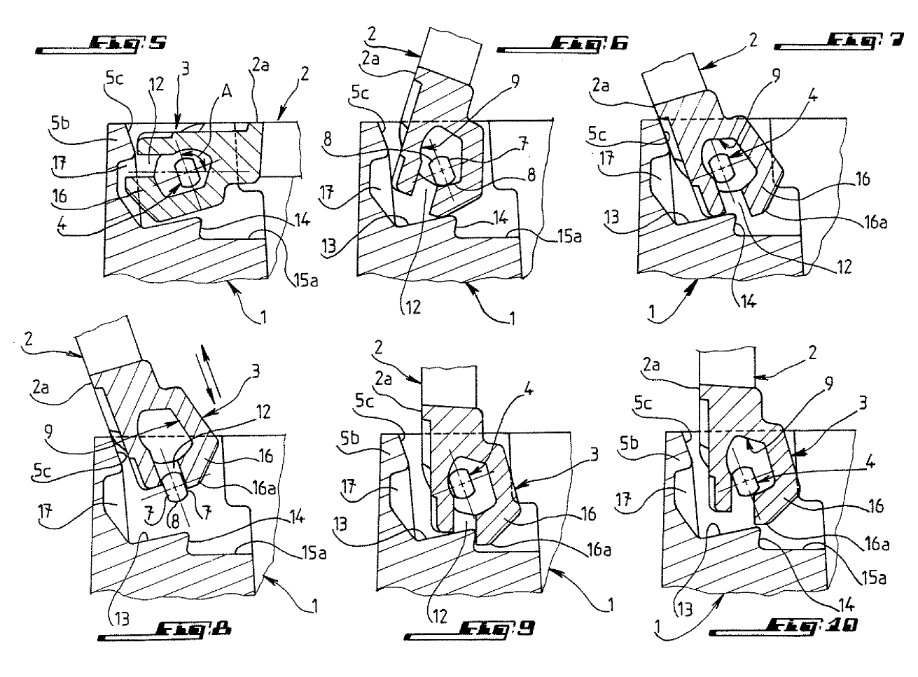

The articulation of plug 2 to frame 1 using hook 3 and pins 4 makes possible a rotation of this plug between a position for closing the frame represented in FIG. 5 to [sic; and] a position for opening this frame represented in FIG. 7, and also allows plug 2 to be extracted from frame 1 in its opening position as will be seen later.

The two hinge pins 4 are connected to the internal surfaces of two lateral walls 5a of lug 5, and each of hinge pins 4 has, in cross section, at least one flat part 7, and preferably two opposite parallel flat parts, having, with respect to frame 1, an inclination A, as represented in FIG. 5, greater than a right angle, with it possible for the value of angle of inclination A of each flat part 7 to be between approximately 110° and approximately 120°. Each hinge pin 4 also has two semi-cylindrical lower and upper surfaces 8.

Hook 3 of plug 2 has two internal lateral openings 9 whose edges are configured in the form of inclines, and which are separated from one another by sheet of material 10 of hook 3 arranged roughly in the longitudinal median plane of hook 3. In the assembled position of hook 3 in lug 5, the two hinge pins 4 are engaged respectively in the two lateral openings 9 of this hook, the edges in the form of inclines of lateral openings 9 being intended for cooperating with the corresponding semi-cylindrical surfaces 8 of the two hinge pins 4 in order to control completely or partially the pivoting of plug 2 from its position for opening to its position for closing frame 1 or vice versa, plug 2, in position of closing of frame 1, being applied on rabbet 11 of frame 1.

Each of lateral openings 9 of hook 3 emerges at the end of this hook through guide 12 of reduced cross section constituting a groove whose parallel surfaces facing one another are separated from one another by a distance slightly greater than the distance separating the two flat parts 7 of the corresponding hinge pin 4.

The reduced cross section of guide 12 has the role of allowing engagement of the corresponding hinge pin 4 in associated lateral opening 9 of hook 3 by mutual drawing of plug 2 in open position near to frame 1 only according to an angle of inclination of this panel relative to frame 1 determined by the angle of inclination of flat parts 7 of hinge pins 4. In this way, plug 2 can be mounted on frame 1 or removed from it only in the overturned position of opening of frame 1 represented in FIG. 7 and in which external surface 2a of plug 2 rests on corresponding inclined upper surface 5c of end wall 5b of lug 5. In this overturned opening position of plug 2 corresponding to an angle of inclination of the plug between approximately 110° and approximately 120° relative to frame 1, plug 2 is maintained in position released from frame 1; and the operation of extraction or positioning of the plug is made simpler and therefore quicker and less delicate for an operator, as shown clearly in FIG. 8.

In its bottom, lug 5 has surface 13 inclined downward towards the exterior of frame 1 and ending towards the interior of this frame with steep side 14 separated from rabbet 11 by bottom wall 15 of lug 5 situated at a level lower than rabbet 11 in order to define slot 15.

Furthermore, hook 3 has heel 16 projecting from an end part of the hook and it can stop against steep side 14, going into slot 15 when plug 2 is tilted accidentally from it overturned opening position of FIG. 7 to its closing position, in such a way as to immobilize plug 2 in opening upright position at an angle of roughly 90° with respect to frame 1, and consequently, to prevent, as a measure of safety, the tilting of plug 2 to its closing position as represented in FIG. 9. In this secure upright position of plug 2 heel 16 is stopped against steep side 14, the other adjacent end part of hook 3 without a heel resting by gravity on the inclined side in the form of incline 13, and the two lateral openings of hook 3 resting by their corresponding inclines respectively on the two hinge pins 4. It is understood that in the overturned opening position of plug 2 represented in FIG. 7 that the end part of hook 3 without heel 16 rests on inclined surface 13, and by the intermediary of the reduced cross sections of guides 12, on the corresponding hinge pins 4 with external surface 2a of this plug resting on inclined surface 5c of lug 5, so that plug 2 can tilt freely from this position to its closing position, either accidentally, in which case plug 2 is automatically immobilized in its upright position of FIG. 9, or in order to allow an operator to bring it to its position for closing frame 1.

When an operator has to pivot plug 2 to its position for closing of frame 1 from the secure upright position of FIG. 9, he lifts plug 2 relative to frame 1 according to a vertical direction as represented in FIG. 10 in order to release plug 2 from frame 1, and the corresponding inclines of lateral openings 9 of hook 3 cooperate with hinge pins 4 so as to prevent extraction of plug 2 from frame 1, that is to say that hinge pins 4 remain in position in their respective lateral openings of hook 3 without being able to escape from them. The operator can then tilt plug 2 to its horizontal position for closing frame 1.

Heel 16 of hook 3 has a shape in the form of cam 16a arranged on the exterior lower corner of this heel and cooperating with inclined surface 13 of frame 1 in order to control the pivoting of plug 2 during its tilting.

End wall 5b of lug 5 moreover has slot 17 hollowed in the internal surface of this wall in order to allow passage of heel 16 of hook 3 during rotation of plug 2 between its closing position and its opening position.

In the application to a rectangular or triangular capping element, the hook of this element can be mounted articulated to frame 1 by a lug as described in the preceding, with it possible for this hook to be mounted articulated between two walls or sheets bearing the two hinge pins 4 and perpendicular to rim 6 and to rabbet 11 of frame 1 in order to constitute an articulation edge of this frame having the same function as that of lug 5.

In order to ensure the mounting of plug 2 on frame 1, external surface 2a of plug 2 is placed resting on upper inclined surface 5c of end wall 5b of lug 5, and the operator, holding plug 2, causes it to slide it naturally by gravity along surface 5c until hinge pins 4 are successfully engaged in the grooves with reduced cross sections of guides 12 and lateral openings 9 of hook 3, as emerges from FIG. 8, and plug 2 is brought to its overturned opening position of FIG. 7. From this position, the operator can freely tilt plug 2 to its closing position by lifting this plug without risk of jamming of hinge pins 4 with lateral openings 9 of hook 3 of this plug.

1-11. (canceled)

12. A device for closing a frame comprising:
a first hinge pin connected to the frame: and
a panel mounted on and articulated with respect to the frame and including a hook connected to the panel, the hook having a first lateral opening defined by internal inclined surfaces cooperating with the first hinge pin, the hook being engageable with the first hinge pin in the first lateral opening for pivoting of the panel from an opening position to a closing position, closing the frame and in which the panel is received in a peripheral rim of the frame, contacting a rabbet of the frame, wherein
the first hinge pin includes a first planar surface which, with respect to the frame, has an inclination greater than a right angle,
the first lateral opening of the hook extends, at an end of the hook, through a first guide of reduced cross sectional area for engagement with and disengagement from the first hinge pin in the first lateral opening of the hook by movement of the panel relative to the frame, in the opening position of the panel, at a specific angle of inclination of the panel relative to the frame, the specific angle of inclination being determined by the planar surface of the first hinge pin, so that the panel can be mounted on or removed from the frame only when rotated beyond the opening position,
the hook and the first hinge pin allow free tilting of the panel beyond the opening position,
the hook, at an end part, has a heel for contacting a steep side of an articulation edge of the frame to immobilize the panel in a secure open upright position, generally perpendicular to the frame, when the panel is tilted beyond the opening position, and
the first hinge pin and the inclined internal surfaces of the first lateral opening of the hook cooperate to prevent removal of the panel from the frame when the panel is in the secure open upright position from the frame, while permitting tilting of the panel to the closing position from the secure open upright position.

13. The device according to claim 12, comprising:
a second hinge pin connected to the frame, wherein
the hook has a second lateral opening, separated from the first lateral opening by a part of the hook and having inclined internal surfaces that cooperate with the second hinge pin, for engaging the second lateral opening of the hook to control pivoting of the panel from the opening position to the closing position,
the second hinge pin has at least one planar surface with the same inclination as the planar surface of the first hinge pin, and
the second lateral opening of the hook extends from the hook through a second guide having a reduced cross sectional area for engagement with and disengagement from the second hinge pin in the second lateral opening of the hook by movement of the panel with respect to the frame, when beyond the opening position, the second hinge pin and the inclination of the second lateral opening of the hook preventing removal from the frame of the panel when the panel is in the secure open upright position.

14. The device according to claim 13, wherein the first and second hinge pins are coaxial.

15. The device according to claim 13, wherein each of the first and second hinge pins has a second planar surface, opposite and parallel to the first planar surface.

16. The device according to claim 13, wherein the articulation edge of the frame has a lower planar surface inclined downward and away from the frame and having an end inclined toward the frame with a stop surface for contacting the heel of the hook.

17. The device according to claim 16, wherein, in the secure open upright position of the panel, the hook rests on a surface adjacent on an inclined surface of the frame and is stopped by a corresponding inclined surface of the first and second lateral openings of the corresponding first and second hinge pins.

18. The device according to claim 17, wherein, when the panel is tilted beyond the opening position, the panel rests on an external surface on an upper inclined surface of a rim of the frame and is stopped from rotation by a corresponding guide with reduced cross section in contact with one of the first and second hinge pins.

19. The device according to claim 16, wherein the heel of the hook includes a cam on an external lower corner that cooperates with an inclined surface of the frame to control the pivoting of the panel.

20. The device according to claim 13, wherein the articulation edge of the frame includes a lug projecting outside the frame for receiving the hook, and each of the first and second hinge pins is within and transverse to the lug.

21. The device according to claim 20, wherein the panel is circular, the hook extends radially from the panel, and the lug is connected radially to the frame.

22. The device according to claim 12, wherein the panel, when tilted beyond the opening position, is inclined at an angle in a range from 110° to 120°, with respect to the frame.
